(19) United States
(12) Patent Application Publication
(10) Pub. No.: US 2021/0086381 A1
(43) Pub. Date: Mar. 25, 2021

(54) SHAVING APPARATUS HAVING MAGNETIC RAZOR ATTACHMENT MEANS

(71) Applicants: Benjamin S. Avery, Oakland, CA (US); Anton Fahlgren, San Francisco, CA (US)

(72) Inventors: Benjamin S. Avery, Oakland, CA (US); Anton Fahlgren, San Francisco, CA (US)

(21) Appl. No.: 16/579,273

(22) Filed: Sep. 23, 2019

(51) Int. Cl. B26B 21/52; B26B 21/22

(52) U.S. Cl. CPC B26B 21/521; B26B 21/222; B26B 21/522

(57) ABSTRACT

A shaver comprising a housing defining a hollow interior recess for receiving a disposable razor blade cartridge, one of the shaver and disposable razor cartridge comprises one or more magnets, the razor blade cartridge sitting flush with a top surface of the housing.

### BACKGROUND OF THE INVENTION

### Field of the Invention

This invention relates to shaving apparatuses, and more particularly relates to shaving devices having detachable razors.

### Description of the Related Art

Shaving devices with detachable razors are well-known in the art. Typically, these razors employ a disposable razor cartridge detachably affixed to a distal end of a handheld shaving implement. Razors are used widely in personal hygiene matters for grooming and to prepare personal appearance typically by removing men's facial hair, but also for removal of hair from legs, the chest, scalp and other areas.

As the blades housed within detachable razor cartridges dull, typically with as little as a few usages, new cartridges are substituted for the old. Although the blades are integrated in many shaving embodiments as a single piece with the handles, because individuals making use of shaving devices prefer rigid, ergonomic designs, it is not economically viable to manufacture disposable handles integrated with blades where the entire unit is intended to be discarded after just a few uses.

Depending on the characteristics of a user's hair, the useful life expectancy of a razor cartridge will vary but is often no more than a single use. Since the quality of razors within cartridges also vary, and because users are constantly switching in dissatisfaction from one shaver to another, users are accustomed to uncertainties in life expectancy and costs of shaving devices.

As novelty in the art has progressed, and as the desire for more progressed designs has evolved, shaving apparatuses have come to include detachable cartridges having an arrangement of a plurality of blades within the detachable cartridge, such as three-blade, four-blade, or even five-blade or higher assemblies. These blades traditionally comprise thin steel blades. As the blades in these disposable cartridges dull, the blades are not sharpened, rather the blades and housing cartridge are disposed of in most cases. These cartridges form a T-shaped, or cross-shaped, component to the shaving apparatus, affixed atop a support structure at a predetermined position and angle. There is no universal fitting or design for disposable cartridges. Disposable cartridges associated with one shaving design are not compatible with others. Inefficiencies in the present state of the art have prevented any one design from gaining any level of dominance as all designs are discarded by dissatisfied users moving on to new products. The disposable cartridges which do exist traditionally snap on over protuberances superiorly jutting from the handle. These cartridges often break when torqueing pressure is applied because of manufacturing considerations driving product makers to weaker disposable cartridges. No efficient mechanism of detachably affixing these cartridges to handles is yet known in the art. Those existing cartridges in the market traditionally snap on using clumsy latching or friction fit mechanisms not sufficient to withstand applied forces, or which loosen over time.

Accordingly, there is a current need for a razor and shaving apparatus which overcomes these inefficiencies in the art. It is therefore desirable that an ergonomic shaving device be provided with advanced stylizing and more efficient disposable cartridge attachment means which does not suffer from the above-described problems. Beneficially, such a shaving device would make use of previously untaught magnetic affixation means.

### SUMMARY OF THE INVENTION

From the foregoing discussion, it should be apparent that a need exists for a shaving apparatus having magnetic attachment means. Beneficially, such an apparatus would overcome many of the difficulties and safety concerns expressed.

The present invention has been developed in response to the problems and needs in the art that have not yet been fully solved by currently available apparatuses and methods. Accordingly, the present invention has been developed to provide a shaving apparatus having magnetic attachment means, the shaving apparatus comprising: a handle having a distal end and proximal end, wherein the handle is wider at the proximal end than at the distal end; a cartridge receiving housing affixed to the distal end of the handle, the cartridge receiving housing comprising: a first ovoid annular rim defining an ellipsoid interior recess adapted to receive a disposable razor cartridge; a second ovoid annular rim circumscribing the first ovoid annular rim interiorly, the second ovoid annular rim forming a platform against which the planar bottom surface of the disposable razor cartridge abuts; wherein the cartridge receiving housing has a planar top surface, a planar bottom surface, an open top end, and open bottom end.

The handle may be one of cylindrical and frustoconical. The housing may be fabricated from a ferromagnetic material. The housing may further comprise one or more elongated magnetics adapted to attract ferromagnetic material within the disposable razor cartridge.

The disposable razor cartridge may sit flush with the planar top surface of the housing when the disposable razor cartridge is received by the housing, such that forces applied across the planar top surface of the housing do not torquedly dislodge the disposable razor cartridge from the housing.

The first annular rim may be subtendedly-arced outward to bulge laterally from the housing.

The disposable razor cartridge may comprise: a blade housing comprising a plurality of razor blades; an uninterrupted sidewall circumscribing the blade housing defining a hollow interior recess; and one or more elongated magnets adapted to attract ferromagnetic material within the housing.

The elongated magnets may be received within a track defined by the blade housing. The top surface of the disposable razor cartridge may be angled away from a lengthwise axis of the handle by 1-45 degrees.

The housing and handle may be formed as a single integrated piece.

A second shaving apparatus having magnetic attachment means is also provided, the shaving apparatus comprising: a handle having a distal end and proximal end, wherein the handle tapers toward the distal end; a cartridge receiving housing affixed to the distal end of the handle, the cartridge receiving housing comprising: a first uninterrupted rim defining an ellipsoid interior recess adapted to receive a disposable razor cartridge; a second rim circumscribing the first uninterrupted rim interiorly, the second rim forming a platform against which the planar bottom surface of the disposable razor cartridge abuts; wherein the cartridge receiving housing has a planar top surface, a planar bottom surface, an open top end, and open bottom end.

The disposable razor cartridge and/or any of its various components may be fabricated partially or entirely from a ferromagnetic material. The disposable razor cartridge may further comprise one or more elongated magnetics adapted to attract ferromagnetic material within the housing.

The disposable razor cartridge may sit flush with the planar top surface of the housing when the disposable razor cartridge is received by the housing, such that forces applied across the planar top surface of the housing do not torquedly dislodge the disposable razor cartridge from the housing.

The first annular rim may be subtendedly-arced outwardly to bulge laterally from the housing. The disposable razor cartridge may comprise: a blade housing comprising a plurality of razor blades; an uninterrupted sidewall circumscribing the blade housing defining a hollow interior recess; and one or more elongated magnets adapted to attract ferromagnetic material within the housing.

The elongated magnets may be received within a track defined by the blade housing. The top surface of the disposable razor cartridge may be angled away from a lengthwise axis of the handle by 1-45 degrees.

The housing and handle may be formed as a single integrated piece.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric perspective view of a shaving apparatus having magnetic attachment means in accordance with the present invention;

FIG. 2 is an exploded isometric perspective view of a shaving apparatus having magnetic attachment means in accordance with the present invention;

FIG. 3 is an isometric perspective view of a detachable magnetic cartridge of a shaving apparatus having magnetic attachment means in accordance with the present invention;

FIG. 4 is a bottom orthographic view of a detachable magnetic cartridge of a shaving apparatus having magnetic attachment means in accordance with the present invention;

FIG. 5 is a top orthographic view of a detachable magnetic cartridge of a shaving apparatus having magnetic attachment means in accordance with the present invention;

FIG. 6 is a sectioned, isometric perspective view of a detachable magnetic cartridge received within a shaving apparatus having magnetic attachment means in accordance with the present invention;

FIG. 7 is a sectioned, isometric perspective view of a detachable magnetic cartridge of a shaving apparatus having magnetic attachment means in accordance with the present invention;

FIG. 8 is a sectioned, orthographic perspective view of a detachable magnetic cartridge of a shaving apparatus having magnetic attachment means in accordance with the present invention;

FIG. 9 is an isometric perspective view of a shaving apparatus having magnetic attachment means and disassembled detachable cartridge in accordance with the present invention;

FIG. 10 is a rearward orthographic view of a detachable magnetic cartridge of a shaving apparatus having magnetic attachment means in accordance with the present invention;

FIG. 11 is a forward orthographic view of a detachable magnetic cartridge of a shaving apparatus having magnetic attachment means in accordance with the present invention;

FIG. 12 is a side orthographic view of a detachable magnetic cartridge of a shaving apparatus having magnetic attachment means in accordance with the present invention;

FIG. 13 is a top orthographic view of a detachable magnetic cartridge of a shaving apparatus having magnetic attachment means in accordance with the present invention; and

FIG. 14 is a bottom orthographic view of a detachable magnetic cartridge of a shaving apparatus having magnetic attachment means in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

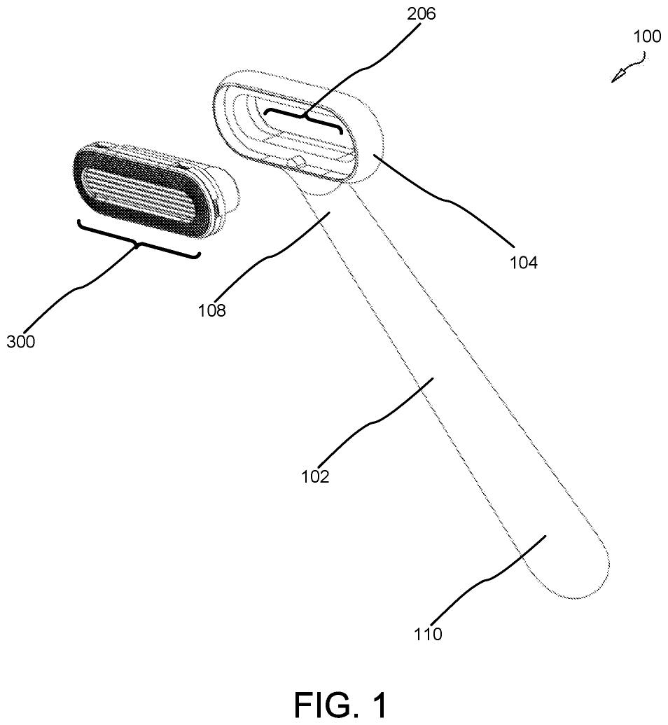

FIG. 1 is an isometric perspective view of a shaving apparatus having magnetic attachment means 100 in accordance with the present invention.

The apparatus 100 comprises an elongated handle 102 stylized, in the shown embodiment, to exclude cornered surfaces. The handle 102 is organically-shaped to maximize ergonomic appeal to a user. The handle 102 is preferably formed as a single integrated piece from steel, titanium, aluminum, iron, metal, copper or other metal alloys known to those of skill in the art; however, the handle 102 may also be formed from polymeric materials or even organic materials such as wood and leather.

One or more organic or polymeric pads may be heat-pressed or otherwise affixed to the handle in some embodiments using means known to those of skill in the art, which the polymeric pads may be textured, rigid, flexible or otherwise adapted to maximize stylizing and user comfort.

The elongated handle 102 may taper toward to the top end, or distal end 108. The handle 102 is meant to be gripped at the distal end by a user's fingers and at the proximal end 110 substantially with a user's palm. For this reason, the handle is wider in diameter at the proximal end 110 than it is at the distal end 108. The handle 102 may be substantially frustoconical in some embodiments.

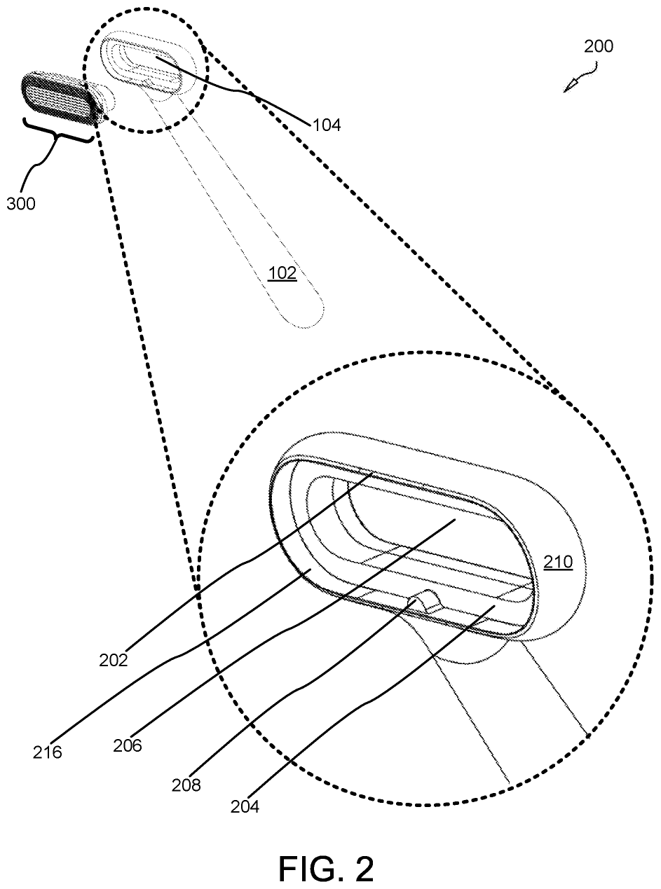

The handle 102 is affixed to a cartridge housing 104, or cartridge receiving portion 104 at the distal end 108. The cartridge receiving portion 104 may be oblong, ovoid, circular and adapted to receive a disposable cartridge 300, the receiving portion 104 further described below in relation to FIG. 2.

FIG. 2 is an exploded isometric perspective view of a shaving apparatus having magnetic attachment means 200 in accordance with the present invention. The exploded view includes the receiving housing 104 adapted to receive a disposable razor cartridge 300.

The apparatus 200 comprises a cartridge receiving portion 104. The cartridge receiving portion 104, or receiving housing 104, comprises an integrated extension of the handle 102 which is shaped ellipsoidly from a top and bottom perspective. The receiving portion 104 may comprise an unbroken annular rim 210 which circumscribes the receiving housing 104. The annular rim 210 may be exteriorly-surfaced to bulge outwardly laterally through the annular rim's 210 medial portion. Said otherwise, the exterior surface of the housing 104 or annular rim 210 may be convex, centrally angled, or subtendedly-arced outward laterally to aesthetically conform to stylizing typified by the organic shape of the handle 102.

The housing 104 comprises a planar top surface 202 and planar bottom surface. The housing 104 has an open top end for receiving the disposable cartridge 300 and an open bottom end through which whiskers, hair, water and shaving cream may filter or drain. The annular rim 210 (or first annular rim 210) and/or the planar top surface 202 define a recess 206 in which the disposable cartridge 300 is detachably inserted. This recess 206 traverses the housing 104 longitudinally from the open top end to the open bottom end. The recess 206 is shaped to contour the exterior surface of a disposable cartridge 300.

In various embodiments, the housing 104 is fabricated from one or more ferromagnetic materials such as iron, nickel or steel which attracts magnets within the disposable cartridge 300. In other embodiments, the housing 104 comprises magnets recessed into the first or second annular rims 210, 206 which attract ferromagnetic materials in the disposable cartridge 300.

The housing 104, in some embodiments, is tiered, or birthday-caked, through the interior recess 206. The housing 104 in the shown embodiment includes a second annular rim 204, ovoid in shape, which interiorly circumscribes the annular rim 210. This interior rim 204 itself defines a secondary recess inferior to the recess 206 which is smaller in area from a top perspective than the recess 206 and through which a portion of the disposable cartridge 300 inserts longitudinally to the housing 104.

The housing 104 positions on its longest axis, in the shown embodiment, perpendicularly to the long axis of the handle 102, forming a cross therewith. The planar top surface and planar bottom surface of the housing 104 are angled away from the long axis of the handle at between 1 and 45 degrees. In various other embodiments, this angle may be adjustable using ratcheting mechanisms or other means known to those of skill in the art. The housing 104 may be hingedly or pivotably connected to the handle 102 in various embodiments, or may be formed therewith as a single integrated piece or unibody.

In various embodiments, the housing 104 comprises one or more protuberances 208 which position interiorly within the recess 206. These protuberances 208 mate with correspondingly-shaped recesses in the disposable cartridge to prevent the disposable cartridge 300 from being inverted, or inserted into the housing 104 upside-down with the blades improperly angled.

The housing 104 is adapted to receive a disposable cartridge 300 such that the cartridge 300 sits flush with the planar top surface of the housing 104. As such, wherein the cartridge 300 does not cantilever or protrude beyond the top of the planar top surface, torque is not applied during use to cartridge 300 which would dislodge the cartridge 300 from the housing 104.

In various embodiments, magnets and/or ferromagnetic blocks position around the superior perimeter 202, or annular rim 202, of the housing 104, or position within housing 104 within the sidewall 216 defining the recess 206. This positioning is intended to ensure that the attachment between the cartridge 300 and handle 102 does not obstruct any open area exposing the blades and to facilitate more efficient access to the blades for rinsing and cleaning.

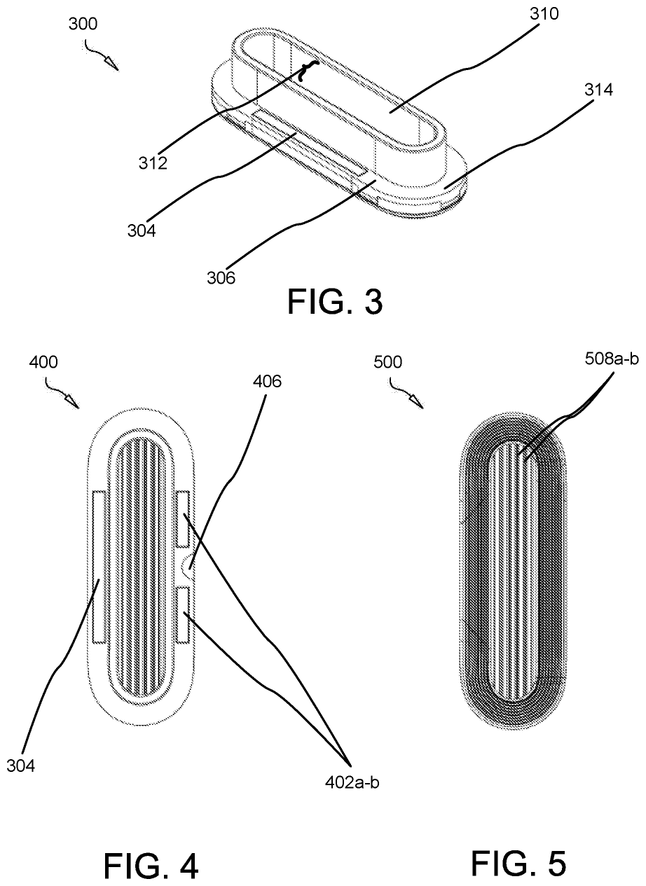

FIG. 3 is an isometric perspective view of a detachable magnetic cartridge of a shaving apparatus having magnetic attachment means 300 in accordance with the present invention.

The detachable magnetic cartridge 300, or disposable razor cartridge 300, comprises an annular ovoid sidewall 310 which circumscribes a planar bottom surface 306 of the cartridge 300. The sidewall 310 defines a hollow interior recess 312 which positions behind various razor blades 508 included in the cartridge 300.

The sidewall 310 is received into the secondary recess defined by the housing 104.

The cartridge 300 comprises a blade housing 314 which envelopes the razor blades 508. The blade housing 314 is received by the recess 206 and sits within the housing 104. The blade housing 314 is also ovoid from a top and bottom perspective and adapted to contour the interior of the annular rim 202.

The sidewall 310 and/or other housing components of the cartridge 300 may be formed from either polymeric and/or ferromagnetic materials such as iron, nickel and steel. In various embodiments, one or more elongated magnetics are recessed into the planar bottom surface 306 and/or the sidewall 310.

FIGS. 4-5 illustrate orthographic views of a detachable magnetic cartridge of a shaving apparatus having magnetic attachment means 400 in accordance with the present invention.

As shown, magnets 402 of different sizes and shapes may be recessed into the disposable cartridge 400. Additionally or alternatively, these magnets 402 may be ferromagnetic metal blocks.

The planar bottom surface 306 of the cartridge 300 defines a recess 406 for receiving the protuberance 208. In various embodiments, magnets and/or ferromagnetic blocks position around the inferior perimeter of the cartridge 300.

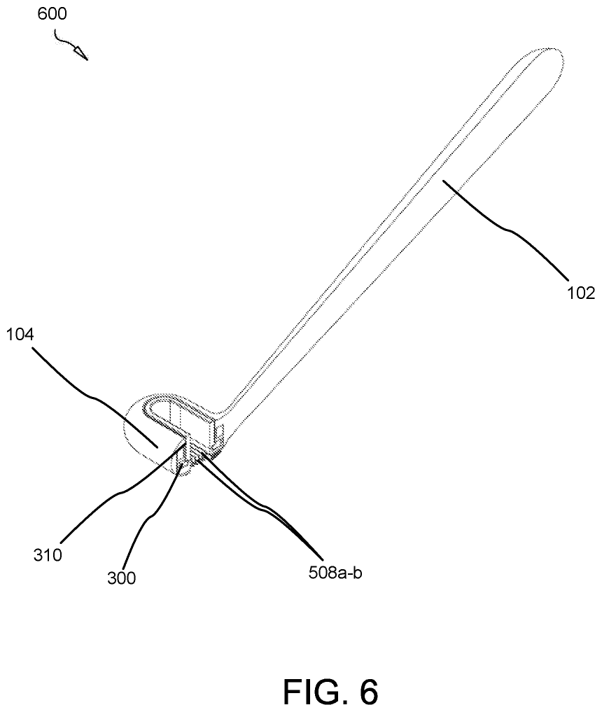

FIG. 6 is a sectioned, isometric perspective view of a detachable magnetic cartridge received within a shaving apparatus having magnetic attachment means 600 in accordance with the present invention.

The cartridge 300 is shown recessed into the housing 104. In various embodiments, the housing 104 comprises magnets 304, 402 intended to attract ferromagnetic materials in the cartridge 300.

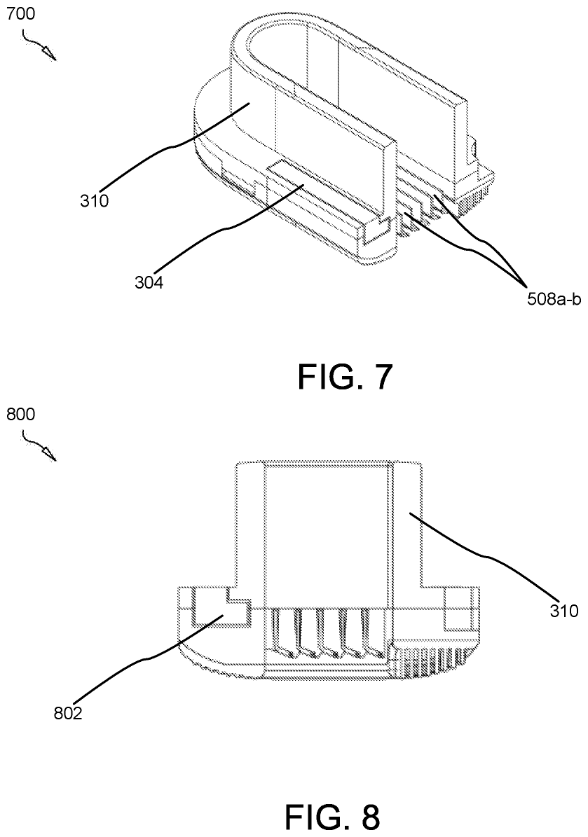

FIG. 7-8 illustrate a sectioned, isometric perspective view of a detachable magnetic cartridge of a shaving apparatus having magnetic attachment means 700, 800 in accordance with the present invention.

As shown, the magnets 304, 402 may slide into a track 802 which cantilevers over a hollow recess into which the magnet 304, 402 is inserted. In other embodiments, the magnets 304, 402 are adhered to the blade housing 314 or fixed in place using a friction fit or via other means known to those of skill in the art.

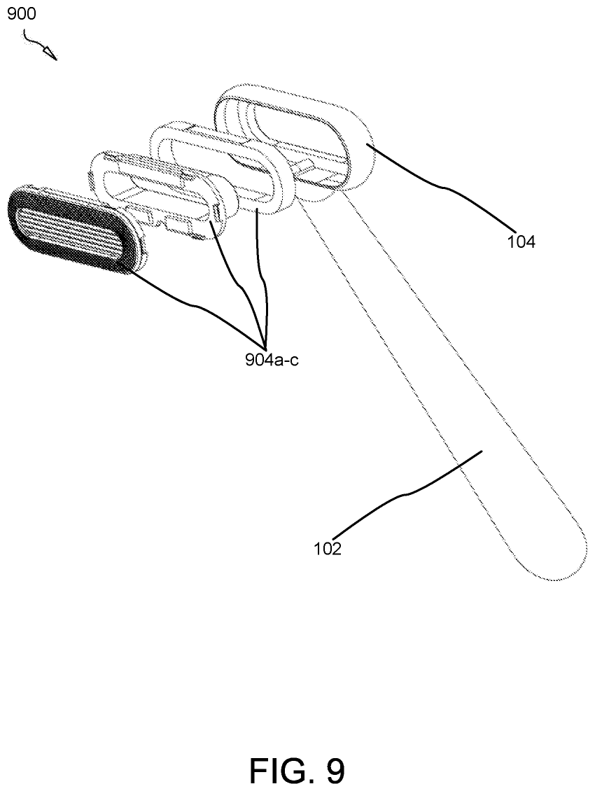

FIG. 9 is an isometric perspective view of a shaving apparatus having magnetic attachment means and disassembled detachable cartridge 900 in accordance with the present invention.

The cartridge 900 as shown may comprise a plurality of polymeric components 904, each adapted to interconnect to form the cartridge 300, 900. The cartridge 900 inserts into the housing 104.

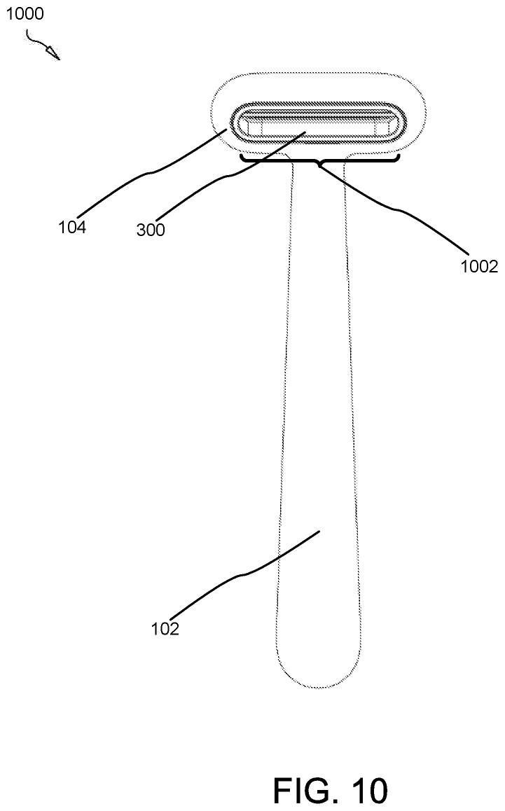

FIG. 10 is a rearward orthographic view of a detachable magnetic cartridge of a shaving apparatus having magnetic attachment means in accordance with the present invention.

The housing 104 defines a secondary recess 1002 and an open bottom end as shown.

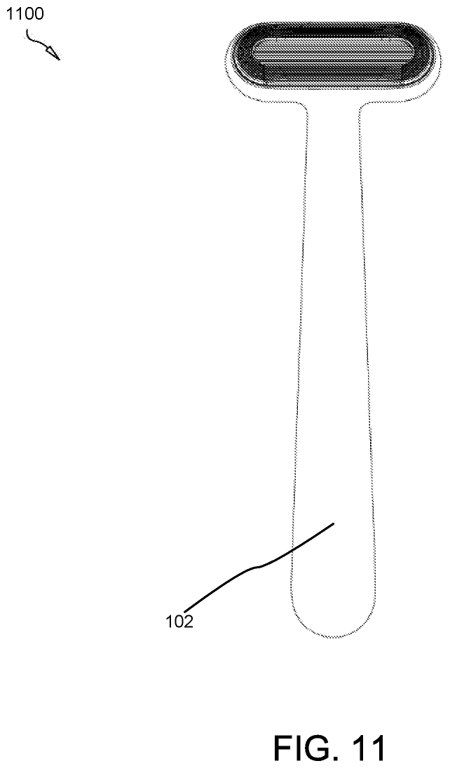

FIG. 11 is a forward orthographic view of a detachable magnetic cartridge of a shaving apparatus having magnetic attachment means in accordance with the present invention.

As shown.

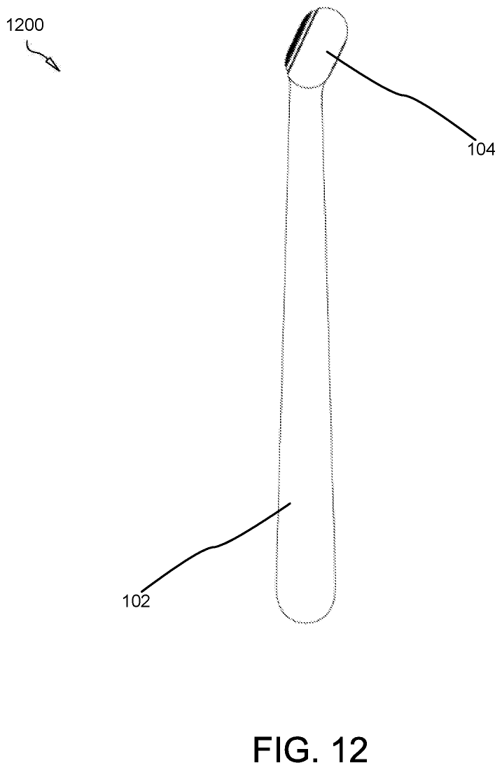

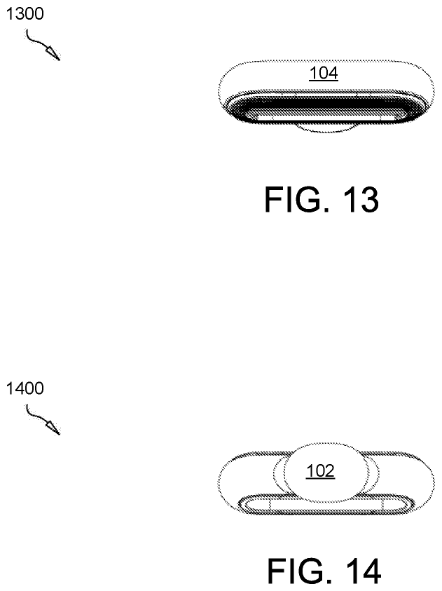

FIGS. 12-14 illustrate varying orthographic views of shaving apparatuses having magnetic attachment means 1200, 1300, 1400 in accordance with the present invention.

The handle 102 is rounded and may be bulbous.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A shaving apparatus having magnetic attachment means, the shaving apparatus comprising:
a handle having a distal end and proximal end, wherein the handle is wider at the proximal end than at the distal end;
a cartridge receiving housing affixed to the distal end of the handle, the cartridge receiving housing comprising:
a first ovoid annular rim defining an ellipsoid interior recess adapted to receive a disposable razor cartridge;
a second ovoid annular rim circumscribing the first ovoid annular rim interiorly, the second ovoid annular rim forming a platform against which the planar bottom surface of the disposable razor cartridge abuts;
wherein the cartridge receiving housing has a planar top surface, a planar bottom surface, an open top end, and open bottom end.

2. The apparatus of claim 1, wherein the handle is one of cylindrical and frustoconical.

3. The apparatus of claim 1, wherein the housing further comprises one or more magnets adapted to attract ferromagnetic material within the disposable razor cartridge.

4. The apparatus of claim 1, wherein the housing is fabricated from a ferromagnetic material.

5. The apparatus of claim 1, wherein the disposable razor cartridge sits flush with the planar top surface of the housing when the disposable razor cartridge is received by the housing, such that forces applied across the planar top surface of the housing do not torquedly dislodge the disposable razor cartridge from the housing during use.

6. The apparatus of claim 1, wherein the first annular rim is subtendedly-arced outward to bulge laterally from the housing.

7. The apparatus of claim 1, wherein the disposable razor cartridge comprises:
a blade housing comprising a plurality of razor blades;
an uninterrupted sidewall circumscribing the blade housing defining a hollow interior recess; and
one or more elongated ferromagnetic blocks adapted to attract magnets within the housing.

8. The apparatus of claim 1, wherein the disposable razor cartridge comprises:
a blade housing comprising a plurality of razor blades;
an uninterrupted sidewall circumscribing the blade housing defining a hollow interior recess; and
one or more elongated magnets adapted to attract ferromagnetic material within the housing.

9. The apparatus of claim 8, wherein a track defined by the blade housing receives one or more of the magnets and ferromagnetic blocks.

10. The apparatus of claim 7, wherein the top surface of the disposable razor cartridge is angled away from a lengthwise axis of the handle by 1-45 degrees.

11. The apparatus of claim 7, wherein:
the housing and handle are formed as a single integrated piece; and
the elongated magnets position around a perimeter of the cartridge receiving housing to ensure that a magnetic attachment between the cartridge receiving housing and a disposable razor cartridge does not obstruct any open area exposing the blades to facilitate more efficient access to the blades for rinsing and cleaning.

12. A shaving apparatus having magnetic attachment means, the shaving apparatus comprising:
an elongated handle having a distal end and proximal end;
a cartridge receiving housing affixed to the distal end of the handle, the cartridge receiving housing comprising:
a first uninterrupted rim defining an interior recess adapted to receive a disposable razor cartridge;
a second rim circumscribing the first uninterrupted rim interiorly, the second rim forming a platform against which the planar bottom surface of the disposable razor cartridge abuts; and
wherein the cartridge receiving housing has a planar top surface, a planar bottom surface, an open top end, and open bottom end;
wherein the cartridge receiving housing and handle are formed as a single integrated piece.

13. The apparatus of claim 12, wherein the disposable razor cartridge comprises a plurality of ferromagnetic components.

14. The apparatus of claim 12, wherein the disposable razor cartridge further comprises one or more magnets adapted to attract ferromagnetic material within the housing.

15. The apparatus of claim 12, wherein the disposable razor cartridge sits flush with the planar top surface of the housing when the disposable razor cartridge is received by the housing, such that forces applied across the planar top surface of the housing do not torquedly dislodge the disposable razor cartridge from the housing.

16. The apparatus of claim 12, wherein the first annular rim is subtendedly-arced outwardly to bulge laterally from the housing.

17. The apparatus of claim 12, wherein the disposable razor cartridge comprises:
a blade housing comprising a plurality of razor blades;
an uninterrupted sidewall circumscribing the blade housing defining a hollow interior recess; and
one or more elongated magnets adapted to attract ferromagnetic material within the housing.

18. The apparatus of claim 17, wherein the elongated magnets are received within a track defined by the blade housing.

19. The apparatus of claim 17, wherein the top surface of the disposable razor cartridge is angled away from a lengthwise axis of the handle by 1-45 degrees.

20. (canceled)

21. A shaving apparatus having magnetic attachment means, the shaving apparatus comprising:
an elongated handle having a distal end and proximal end;
a cartridge receiving housing affixed to the distal end of the handle, the cartridge receiving housing comprising:
a first rim defining an interior recess adapted to receive a disposable razor cartridge;
a second rim circumscribing the first rim interiorly, the second rim forming a platform against which the planar bottom surface of the disposable razor cartridge abuts; and
wherein the cartridge receiving housing has a planar top surface, a planar bottom surface, an open top end, and open bottom end;
wherein the cartridge receiving housing and handle are formed as a single integrated piece.
